(19) United States
(12) Patent Application Publication
(10) Pub. No.: US 2026/0202066 A1
(43) Pub. Date: Jul. 16, 2026

(54) COOKING APPLIANCE

(71) Applicant: LG ELECTRONICS INC., Seoul (KR)

(72) Inventors: Wontae KIM, Seoul (KR); Haemin KIM, Seoul (KR); Jaeho LEE, Seoul (KR); Seongsoon AHN, Seoul (KR)

(21) Appl. No.: 19/135,541

(22) PCT Filed: Dec. 6, 2023
(86) PCT No.: PCT/KR2023/020030

§ 371 Date: Jun. 4, 2025

(30) Foreign Application Priority Data
Dec. 6, 2022 (KR) 10-2022-0168536

(51) Int. Cl. F24C 15/20; H05B 6/64

(52) U.S. Cl. CPC F24C 15/2042; H05B 6/6423

(57) ABSTRACT

An invention related to a cooking appliance is disclosed. In the disclosed invention, a fan assembly for suctioning air into the cooking appliance, and then exhausting same to the outside of the cooking appliance is disposed in the cooking appliance, the fan assembly being disposed in the space between the back surface of a cavity in which a cooking chamber is formed, and a rear plate which forms the rear exterior of the cooking appliance.

### TECHNICAL FIELD

The present disclosure relates to a cooking appliance, and more particularly, to a cooking appliance which provides both a cooking function and a hood function.

### BACKGROUND ART

A cooking appliance is a home appliance for cooking food, and is an apparatus installed in a kitchen space to cook food according to a user's intention. Such cooking appliances may be variously classified according to a heat source, a form, or a type of fuel to be used.

When the cooking appliances are classified according to the type of food being cooked, the cooking appliances may be classified into open type and closed type cooking appliances according to a type of space in which the food is placed. The closed type cooking appliance includes an oven, a microwave oven, etc. and the open type cooking appliance includes a cooktop, a hop, etc.

The closed type cooking appliance is a cooking appliance that encloses a space in which food is located and heats the enclosed space to cook food. In the closed type cooking appliance, a chamber, that is, a cooking chamber, which is a space that is enclosed when food is to be cooked while the food is placed, is provided inside the main body. Such a cooking chamber becomes a space in which food is substantially cooked. A heat source is provided in the inner or outer space of the cooking chamber to heat the cooking chamber.

The microwave of the closed type cooking appliance is a cooking apparatus which generates microwaves using electricity to extend through into an object to be cooked accommodated in a cooking chamber, thereby heating the object to be cooked by causing molecular movement therein.

A microwave oven is a kitchen appliance which simultaneously heats the inside and the outside of the food by irradiating the high frequency wave from the magnetron to the food, and is widely used due to advantages such as significantly shortening the cooking time of the food due to high thermal efficiency, reducing the loss of nutritional value during cooking, defrosting, and heating of the food, and enabling direct cooking while the food is stored in a container.

Recently, a microwave oven combined with a hood function also known as an OTR (Over the Range) type microwave oven has been released. The OTR type microwave oven having the hood has a hood function of discharging air (hereinafter referred to as “cooking gas”) containing foreign substances generated in the process of cooking food from a cooking appliance installed thereunder, or filtering the cooking gas and then discharging the filtered gas to the inside.

A fan for suctioning and discharging air is provided in the hood-combined microwave oven. Such a fan is typically disposed on top of the cavity defining the cooking chamber therein. That is, in the microwave oven having the hood, the fan is generally disposed on top of the cavity.

However, when the fan is disposed at the position as described above, a distance between the fan and a suction hole disposed at a lower end of the hood-combined microwave oven is greater than a vertical length of the cavity. As described above, the distance between the suction hole and the fan is increased, such that the cooking gas collection performance of the microwave oven having the hood is inevitably lowered. This is because a flow rate of the suctioned airflow generated by the fan may be lowered in a manner inversely proportional to a square of the distance from the fan to the suction hole.

In addition, when the fan is disposed at the above-described position, an entirety of the vertical length of the hood-combined microwave oven is inevitably increased. Thus, when the hood-combined microwave oven having the increased vertical length is installed in an upper cabinet, the possibility that the hood-combined microwave oven protrudes downwardly beyond the upper cabinet is increased.

When the microwave oven having the hood protrudes downwardly beyond the upper cabinet, aesthetics thereof is not good, and a problem in which a spacing between a cooktop installed under the upper cabinet and the microwave oven having the hood is smaller may occur.

When the spacing between the cooktop and the microwave oven having the hood is smaller as the microwave oven having the hood protrudes downwardly beyond the upper cabinet, a problem in which the microwave oven having the hood screens the field of view of the user who wants to use the cooktop and a problem in which a cooking area of the cooktop is smaller may occur.

SUMMARY OF DISCLOSURE

### Technical Purpose

A purpose of the present disclosure is to provide a cooking appliance with an improved structure to provide a hood function while suppressing an increase in a total vertical length of the cooking appliance.

In addition, still another purpose of the present disclosure is to provide a cooking appliance having an improved structure so as to reduce a flow loss generated inside the cooking appliance while suppressing an increase in a total volume of the cooking appliance.

### Technical Solution

The cooking appliance for achieving the above purpose according to an embodiment of the present disclosure is characterized in that a fan assembly for suctioning air into the inside of the cooking appliance and then discharging the air to the outside out of the cooking appliance is disposed in rear of a cavity having a cooking chamber defined therein.

In addition, a cooking appliance of another aspect of the present disclosure is characterized in that a fan assembly for suctioning air into the inside of the cooking appliance and then discharging the air to the outside out of the cooking appliance is disposed inside the cooking appliance, and is disposed in a space defined in rear of the cavity.

In addition, a cooking appliance of according to still another aspect of the present disclosure is characterized in that a fan assembly for suctioning air into the inside of the cooking appliance and discharging the air to the outside out of the cooking appliance is disposed inside the cooking appliance, and is disposed in a space between a rear surface of a cavity having a cooking chamber defined therein and a rear plate constituting an outer appearance of a rear surface of the cooking appliance.

In addition, a cooking appliance of according to still yet another aspect of the present disclosure is characterized in that fan assemblies for suctioning air into the cooking appliance and discharging the air to the outside out of the cooking appliance are respectively disposed in an area in rear of and an area on a lateral side of a cavity having a cooking chamber defined therein.

In addition, the fan assembly having a smaller size than the fan assembly disposed in the area in rear of the cavity may be disposed in the area on the lateral side of the cavity.

A cooking appliance according to one aspect of the present disclosure may include: a main body including a cavity having a cooking chamber defined therein; and a blower disposed inside the main body.

In addition, the main body may include an intake hole disposed below the blower, and an exhaust hole disposed above the intake hole.

In addition, the blower may include a first blower and a second blower that suction air through the intake hole and discharge the suctioned air to the exhaust hole.

In addition, the first blower may be disposed in rear of the cavity.

In addition, the second blower may be disposed on the lateral side of the cavity.

Further, the main body may further include a rear plate disposed in rear of the cavity.

The first blower may be disposed in a rear space defined between the cavity and the rear plate.

In addition, a rearward protruding surface may be formed on at least a portion of the rear plate.

In addition, the rearward protruding surface constitutes a surface that protrudes rearward beyond the remaining area of the rear plate except for the rearward protruding surface.

In addition, the first blower may be disposed in an area overlapping the rearward protruding surface in the front-rear direction.

Moreover, the main body may further include a cabinet having an upper surface disposed above the cavity.

Moreover, the exhaust hole may communicate with an upper space defined between the upper surface of the cavity and the upper surface of the cabinet.

In addition, the first blower and the second blower discharge the suctioned air to the upper space.

In addition, the exhaust hole may be formed to extend through the upper surface of the cabinet.

In addition, the exhaust hole may be disposed in an area overlapping the first blower in the vertical direction.

In addition, the first blower may be disposed at a position overlapping the cavity in the front-rear direction.

In addition, the main body may further include a cabinet having a side surface disposed on a lateral side of the cavity.

Moreover, the second blower may be disposed in a side space defined between the side surface of the cavity and the side surface of the cabinet.

In addition, an electronic/electrical component chamber may be formed inside the main body, wherein the side space may include a pair of side spaces respectively disposed on both opposing sides in the lateral direction of the cavity, wherein the electronic/electrical component chamber may be disposed in one of a pair of the side spaces, and the second blower may be disposed in the other of the pair of the side spaces.

In addition, in the vertical direction, at least one of the first blower and the second blower may be disposed between the upper surface and the lower surface of the cavity.

In addition, in the vertical direction, the first blower may be disposed at a position closer to the intake hole than the second blower may be.

Moreover, the first blower may include at least one of a first fan assembly and a second fan assembly.

In addition, the second blower includes the second fan assembly.

In addition, each of the first fan assembly and the second fan assembly may have a suction hole disposed to face in a lateral direction or a front-rear direction and a discharge hole disposed to face upwardly.

In addition, in the first blower, the suction hole of each of the first fan assembly and the second fan assembly may be disposed to face in the lateral direction.

In addition, in the second blower, the suction hole of the second fan assembly may be disposed to face in the front-rear direction.

In addition, in a direction perpendicular both the direction in which the suction hole faces and the direction in which the discharge hole faces, the length of the second fan assembly is smaller than the length of the first fan assembly.

Moreover, the first blower may include a plurality of the second fan assemblies arranged in a lateral direction.

In addition, in the first blower, a vertical position of the second fan assembly may be a position closer to the intake hole than to the exhaust hole.

### Technical Effect

The cooking appliance of the present disclosure may be configured such that the blower for providing the hood function is disposed on the lateral side of the cavity or in rear of the cavity rather than above the cavity, thereby providing the hood function while suppressing the increase in the vertical length of the cooking appliance.

In addition, according to the present disclosure, the fan assemblies may be respectively disposed in both the side space and the rear space, thereby effectively improving the cooking gas removal performance of the cooking appliance.

In addition, according to the present disclosure, the blower may be constructed such that the second fan assembly which is more suitable to be disposed in a narrow space is disposed in the side space, and the first fan assembly having higher performance than that of the second fan assembly is disposed in the rear space providing a more sufficient space than the side space may, thereby suppressing an increase in the size of the cooking appliance and providing more improved cooking gas removal performance at the same time.

In addition, the cooking appliance of the present disclosure employs a structure in which the first fan assembly is disposed in the rear space connected to and arranged with the exhaust hole in the straight line, thereby minimizing the flow loss inside the cooking appliance, thereby providing further improved cooking gas removal performance.

In addition, the cooking appliance of the present disclosure can effectively secure the filter installation space in the upper space, thereby providing an effect of maintaining a compact size and smoothly filtering the cooking gas and discharging the cooking gas to the indoor space.

### BRIEF DESCRIPTION OF DRAWINGS

FIG. 1 is a perspective view illustrating a cooking appliance according to an embodiment of the present disclosure.

FIG. 2 is a perspective view showing an internal structure of the cooking appliance shown in FIG. 1 in a see-through state.

FIG. 3 is a front view illustrating an internal structure of the cooking appliance illustrated in FIG. 2.

FIG. 4 is a plan view showing an internal structure of the cooking appliance shown in FIG. 2.

FIG. 5 is a side view illustrating an internal structure of the cooking appliance illustrated in FIG. 2.

FIG. 6 is a rear perspective view illustrating an internal structure of the cooking appliance illustrated in FIG. 2.

FIG. 7 is a plan view illustrating a first fan assembly separated from the cooling appliance as illustrated in FIG. 2.

FIG. 8 is a plan view illustrating a second fan assembly separated from the cooling appliance as illustrated in FIG. 2.

FIGS. 9 and 10 are diagrams showing a state in which cooking gas is discharged into an outdoor space in the cooking appliance according to an embodiment of the present disclosure.

FIG. 11 is a diagram showing a state in which cooking gas is discharged into an indoor space in the cooking appliance according to an embodiment of the present disclosure.

FIG. 12 is a perspective view illustrating an internal structure of a cooking appliance according to another embodiment of the present disclosure in a see-through state.

FIG. 13 is a front view illustrating an internal structure of the cooking appliance illustrated in FIG. 12.

FIG. 14 is a plan view showing an internal structure of the cooking appliance shown in FIG. 12.

FIG. 15 is a side view illustrating an internal structure of the cooking appliance illustrated in FIG. 12.

FIG. 16 is a rear perspective view illustrating an internal structure of the cooking appliance illustrated in FIG. 12.

FIGS. 17 and 18 are diagrams illustrating a state in which cooking gas is discharged into an outdoor space in the cooking appliance according to another embodiment of the present disclosure.

FIG. 19 is a diagram showing a state in which cooking gas is discharged into an indoor space in the cooking appliance according to another embodiment of the present disclosure.

### DETAILED DESCRIPTIONS

The above-described purposes, features and advantages will be described in detail with reference to the accompanying drawings, and accordingly, a person having ordinary skill in the art to which the present disclosure belongs will be able to easily implement the technical idea of the present disclosure. In describing the present disclosure, a detailed description of known technologies related to the present disclosure will be omitted when it is determined that the gist of the present disclosure may be unnecessarily unclear. Hereinafter, preferred embodiments according to the present disclosure will be described in detail with reference to the accompanying drawings. In the drawings, the same reference numerals are used to refer to the same or similar components.

Although the first, second, and the like are used to describe various components, these components are not limited by these terms. These terms are only used to distinguish one component from another component, and it is obvious that the first component may be the second component unless there is a particular opposite description.

The present disclosure is not limited to the embodiments disclosed below. However, various changes may be applied thereto and the present disclosure may be implemented in various forms different from each other. However, the present embodiment is provided so that the present disclosure is complete and the scope of the present disclosure is fully known to those of ordinary skill in the art. Therefore, the present disclosure is not limited to the embodiments disclosed below, but it should be understood that the present disclosure includes all changes, equivalents, and substitutes included in the technical spirit and scope of the present disclosure, as well as includes replacing the configuration of one embodiment with the configuration of another embodiment and adding the configuration of another embodiment to the configuration of one embodiment.

The accompanying drawings are only set forth for the skilled person to the art to easily understand the embodiments disclosed in the present disclosure, and the technical spirit disclosed in the present disclosure is not limited by the accompanying drawings, and it should be understood that all changes, equivalents, and substitutes included in the spirit and technical scope of the present disclosure are included in the present disclosure. In the drawings, the components may be expressed in an exaggerated or small size in consideration of convenience of understanding or the like. However, the scope of protection of the present disclosure should not be limited thereto.

The terms used herein are used only to describe specific embodiments or implementations, and are not intended to limit the present disclosure. Further, the singular expression of a component includes the plural expression thereof unless the context clearly indicates otherwise. In the present disclosure, the terms “include,” “composed of”, etc. are intended to designate that the features, numbers, steps, operations, components, parts, or combinations thereof described in the present disclosure are present. That is, it should be understood that the terms such as “include” and “composed of” in the present disclosure do not exclude the possibility of the presence or addition of one or more other features, numbers, steps, operations, components, parts, or combinations thereof.

The terms including ordinals, such as first and second, may be used to describe various components, but the components are not limited by the terms. The terms are used only for the purpose of distinguishing one component from another component.

When it is mentioned that one component is “connected” or “coupled” to another component, it should be understood that one component may be directly connected or coupled to another component, or there may be still another component disposed therebetween. On the other hand, when it is stated that one component is “directly connected” or “directly coupled” to another component, it should be understood that still another component is absent therebetween.

When it is mentioned that a component is “above” or “below” another component, it should be understood that still another component may be present or absent therebetween.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In a state in which the cooking appliance is placed on the floor, a side at which the door is installed around a center of the cooking appliance is defined as a front side. Therefore, when the door is opened, the cooking target enters the cavity of the cooking appliance in a rear direction. For convenience, a front-rear direction may be referred to as a first direction. In this regard, the front side may be referred to as one side in the first direction, and the rear side may be referred to as the other side in the first direction.

In addition, the direction of gravity may be defined as a downward direction and the direction opposite to the direction of gravity may be defined as an upwardly direction.

In addition, a horizontal direction orthogonal to the front-rear direction of the cooking appliance, that is, a width direction of the cooking appliance in a front view of the door of the cooking appliance may be referred to as a left-right direction. For convenience, the left-right direction may be referred to as a second direction. Then, the right side may be referred to as one side in the second direction, and the left side may be referred to as the other side in the second direction.

In addition, the width direction of the cooking appliance may be referred to as a lateral direction. Then, the right side may be referred to as one side in the lateral direction, and the left side may be referred to as the other side in the lateral direction.

In addition, the above-described vertical direction may be referred to as a third direction. Then, the upper side may be referred to as one side in the third direction, and the lower side may be referred to as the other side in the third direction.

The front-rear direction and the left-right direction, that is, the first direction and the second direction may be first and second horizontal directions.

Throughout the present disclosure, “A and/or B” means A, B, or A and B, unless otherwise specified, and “C to D” means C inclusive to D inclusive unless otherwise specified.

### Overall Structure of Cooking Appliance

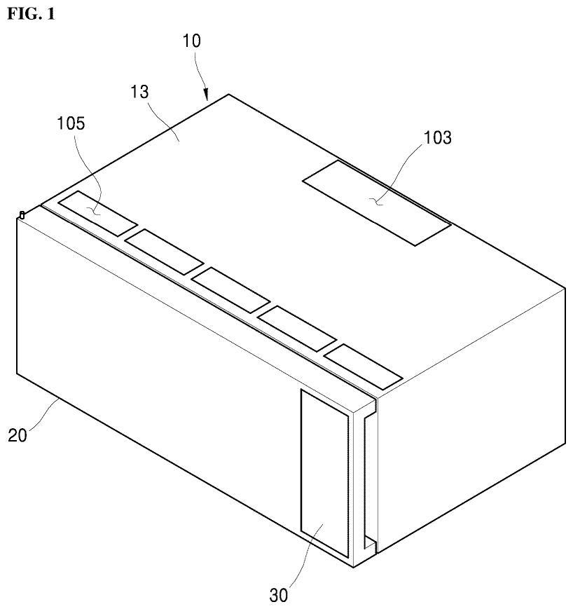

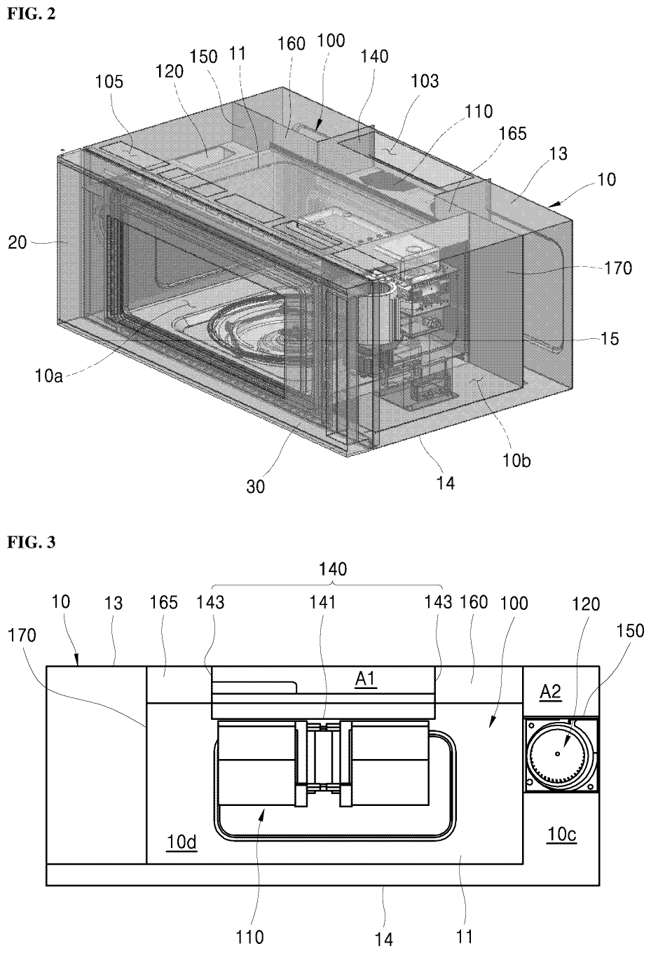

FIG. 1 is a perspective view illustrating a cooking appliance according to an embodiment of the present disclosure. FIG. 2 is a perspective view showing an internal structure of the cooking appliance shown in FIG. 1 in a see-through state.

Referring to FIGS. 1 to 2, the cooking appliance according to an embodiment of the present disclosure has an outer appearance defined by the main body 10. The main body 10 may be provided in a shape including a substantially rectangular parallelepiped shape, and may be made of a material having a predetermined strength to protect a plurality of components installed in an inner space defined therein. The main body 10 may include a cavity 11, a cabinet 13, and a base plate 14.

The cavity 11 may constitute an internal skeleton of the main body 10. The cavity 11 may be formed in the form of a hexahedron with an open front surface. A cooking chamber 10a may be formed inside the cavity 11. The cooking chamber 10a may be formed in a shape corresponding to an inner shape of the cavity 11, that is, a hexahedral shape with an open front surface.

The cooking chamber 10a may be formed in a hexahedral shape with an open front surface. While the cooking chamber 10a is enclosed, cooking may be performed while the inner space of the cooking chamber 10a is heated. That is, in the cooking appliance, the inner space of the cooking chamber 10a is a space in which food is substantially cooked.

A front plate 12 may be disposed in front of the cavity 11. The front plate 12 may define a front appearance of the main body 10 in front of the cavity 11. In an example, the front plate 12 may be provided in the form of a metal plate having a hollow.

The cabinet 13 may define an outer appearance of the main body 10 while being disposed on an outer side of the cavity 11. The cabinet 13 may cover the cavity 11 at upper and side portions thereof and may define the outer appearance of the main body 10.

The base plate 14 may be disposed on a lower side of the cavity 11. The base plate 14 may constitute a bottom surface of the cooking appliance, and may cover the cavity 11 at a lower side of the cavity 11.

In addition, the main body 10 may further include a rear plate 15. The rear plate 15 may be disposed on a rear side of the cavity 11. The rear plate 15 may constitute a rear surface of the cooking appliance, and may cover the cavity 11 while being disposed in rear of the cavity 11.

The rear plate 15 may be integrally formed with the cabinet 13, or may be formed separately from the cabinet 13.

A door 20 for selectively opening and closing the cooking chamber 10a may be pivotably provided on a front surface of the main body 10. The door 20 may open and close the cooking chamber 10a in a side-swinging manner in which the other side in the lateral direction thereof pivots in a left or right direction around one side in the lateral direction thereof.

The door 20 may be generally formed in a hexahedral shape having a predetermined thickness. In addition, a hinge may be installed at between the main body 10 and the door 20. The hinge may be disposed on one side in the lateral direction of the main body 10 to pivotably couple one side in the lateral direction of the door 20 to the main body 10. The door 20 may be pivotably coupled to the hinge while being disposed on the front surface of the main body 10, and may open and close the cooking chamber 10a while pivoting about the hinge.

In addition, a cooking chamber heat source for heating the inside of the cooking chamber 10a is provided inside the main body 10. The cooking chamber heat source may be implemented in one type, or may be implemented in two or more types.

In the present embodiment, an example in which the cooking chamber heat source includes a magnetron capable of supplying a high frequency heat source to the inside of the cooking chamber 10a is described. In this regard, the magnetron may be installed inside the main body 10, and may be installed to be located on an upper or lower side of the cooking chamber 10a.

In addition, an electronic/electrical component chamber 10b located on an upper surface or a side surface of the cooking chamber 10a and in the main body 10 may be defined inside the main body 10. In the present embodiment, it is illustrated that the magnetron and the electronic/electrical component chamber 10b are disposed on the side surface of the cooking chamber 10a. Electronic components such as the magnetron and a high-voltage transformer may be installed inside the electronic/electrical component chamber 10b.

In addition, a control panel 30 may be provided at a front side of the main body 10. In one example, the control panel 30 may be disposed on the door 20.

The control panel 30 may be formed in a hexahedral shape having a predetermined internal space defined therein, and an input unit for inputting a manipulation signal for operating the cooking appliance by a user may be provided on a front surface of the control panel 30. A plurality of manipulation switches are provided in the input unit, and the user may directly input an operation signal thereon.

In another example, the control panel 30 may be disposed in front of the cavity 11. The control panel 30 may be disposed in an area not overlapping the cooking chamber 10a in the front-rear direction. For example, the electronic/electrical component chamber 10b may be disposed on the side surface of the cooking chamber 10a, and the control panel 30 may be disposed on the front side of the electronic/electrical component chamber 10b.

In addition, the cooking appliance of the present embodiment may further include a blower 100. In addition, the main body 10 may have an air intake hole 101, and an first exhaust hole 103 and a second exhaust hole 105.

The air blower 100 may be accommodated in the cooking appliance, and may suction the cooking gas through the air intake hole 101 and discharge the suctioned cooking gas to the outside out of the cooking appliance through at least one of the first exhaust hole 103 and the second exhaust hole 105.

### Overall Structure of Components Related to Hood Function

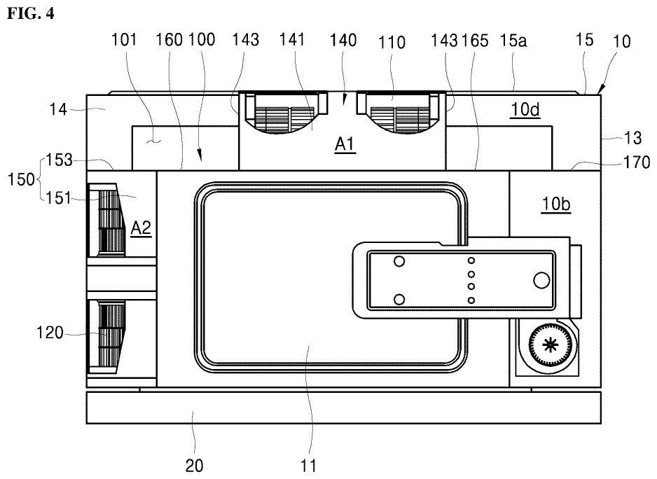

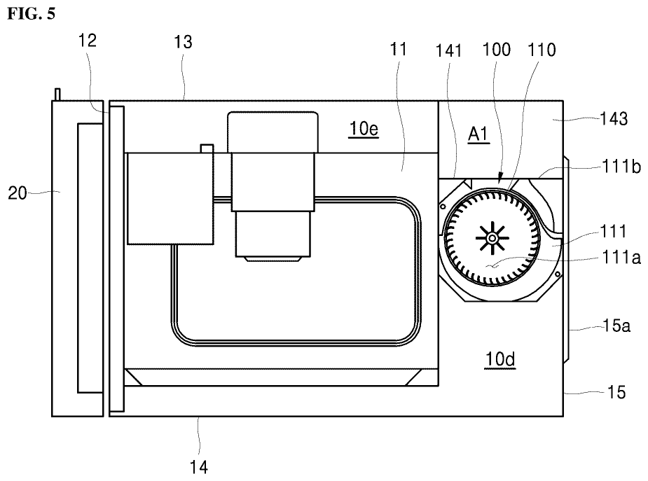

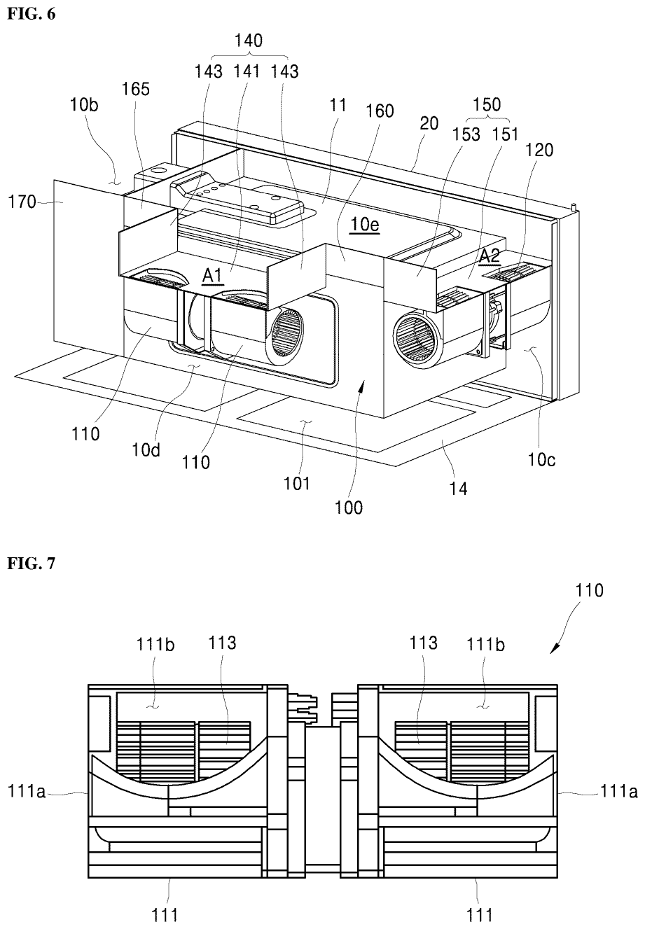

FIG. 3 is a front view showing an internal structure of the cooking appliance shown in FIG. 1, and FIG. 4 is a plan view showing an internal structure of the cooking appliance shown in FIG. 1. FIG. 5 is a side view illustrating an internal structure of the cooking appliance shown in FIG. 1, and FIG. 6 is a rear perspective view illustrating an internal structure of the cooking appliance shown in FIG. 1.

Referring to FIGS. 2 to 6, the air intake hole 101 may be disposed in a lower end of the cooking appliance. In one example, the air intake hole 101 may be defined in the base plate 14. The air intake hole 101 may constitute a passage for introducing the cooking gas into the cooking appliance such that the passage is defined at the lower end of the cooking appliance. In the present embodiment, it is illustrated that each of a pair of air intake holes 101 are disposed under a side space 10c as will be described below.

The first exhaust hole 103 and the second exhaust hole 105 may be disposed in an upper end of the cooking appliance. The first exhaust hole 103 and the second exhaust hole 105 may constitute a passage for discharging the cooking gas suctioned into the cooking appliance to the outside out of the cooking appliance such that the passage is defined in the upper end of the cooking appliance.

In one example, the first exhaust hole 103 and the second exhaust hole 105 may be defined in the upper surface of the cabinet 13. The first exhaust hole 103 and the second exhaust hole 105 may be formed in the upper surface of the cabinet 13 so as to extend through the cabinet 13 in a vertical direction.

The first exhaust hole 103 may be disposed in a rear portion of the upper surface of the main body 10. In addition, the second exhaust hole 105 may be disposed at the front side of the upper surface of the main body 10. That is, the second exhaust hole 105 may be disposed at a side adjacent to the door 20, and may be disposed to be closer to the front side than the first exhaust hole 103 may be.

The first exhaust hole 103 may constitute a passage for discharging the cooking gas suctioned into the cooking appliance to the outside. The second exhaust hole 105 may constitute a passage for discharging the cooking gas suctioned into the cooking appliance into an indoor room.

In one example, the first exhaust hole 103 may be disposed in an area overlapping an upper cabinet in which the cooking appliance is received in the vertical direction. In addition, the second exhaust hole 105 may be disposed at a position protruding in a frontward direction beyond the upper cabinet.

In addition, the first exhaust hole 103 may be disposed approximately at a center in the lateral direction of the main body 10. In addition, a plurality of second exhaust holes 105 may be arranged in the lateral direction and may be positioned at the front side of the upper surface of the main body 10.

The first exhaust hole 103 disposed approximately at the center in the lateral direction of the main body 10 as described above may be connected to an exhaust duct connected to the outdoor. The plurality of second exhaust holes 105 arranged in the lateral direction may discharge the cooking gas from a position in front of the upper cabinet to a position on top of the cooking appliance. In this regard, the cooking gas may be discharged through the second exhaust hole 105 in a state of being filtered inside the cooking appliance.

A space may be formed in the main body 10. The space may be disposed between the cavity 11 and the cabinet 13.

The space may be divided into the side space 10c and a rear space 10d. The side space 10c may be disposed on each of both opposing sides in the lateral direction of the cavity 11. In addition, the rear space 10d may be disposed on the rear side of the cavity 11.

For example, each side space 10c may be a space defined between each side surface of the cavity 11 and each side surface of the cabinet 13. In addition, the rear space 10d may be a space defined between the rear surface of the cavity 11 and the rear plate 15.

The electronic/electrical component chamber 10b may be disposed in one of the side spaces 10c. In the present embodiment, it is illustrated that the electronic/electrical component chamber 10b is provided in the side space 10c disposed in rear of the control panel 30.

The blower 100 may be disposed inside the main body 10. More specifically, the air blower 100 may be disposed in the space, that is, the space between the cavity 11 and the cabinet 13. The blower 100 may include at least one fan assembly 110.

The fan assembly 110 may generate an airflow for suctioning the cooking gas outside the cooking appliance and discharging the cooking gas to the outside out of the cooking appliance. The fan assembly 110 may introduce the cooking gas into the main body 10 through the air intake hole 101 and discharge the introduced cooking gas through at least one of the first exhaust hole 103 and the second exhaust hole 105 out of the main body.

At least one of the fan assembly 110 provided in the blower 100 may be disposed in the rear space 10d. Accordingly, the cooking gas introduced into the main body 10 through the air intake hole 101 may flow through the rear space 10d and then be discharged through the first exhaust hole 103 or the second exhaust hole 105. A detailed arrangement structure of the fan assembly 110 will be described later.

In addition, an upper space 10e may be further provided inside the main body 10. The upper space 10e may be disposed above the cavity 11.

For example, the upper space 10e may be defined between the upper surface of the cavity 11 and the upper surface of the cabinet 13. The upper space 10e may be connected to the rear space 10d.

That is, the air introduced into the rear space 10d may flow through the upper space 10e and be discharged to the outside out of the cooking appliance through the first exhaust hole 103 or the second exhaust hole 105. In addition, the air introduced into the side space 10c may also flow through the upper space 10e and may be discharged to the outside out of the cooking appliance through the first exhaust hole 103 or the second exhaust hole 105.

### One Embodiment of Blower

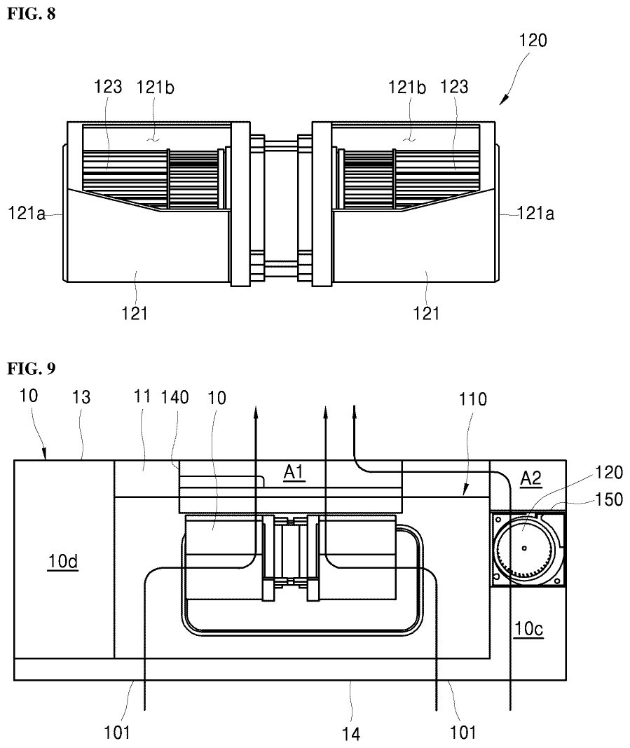

FIG. 7 is a plan view illustrating a first fan assembly shown in FIG. 2 as separated from the cooking appliance, and FIG. 8 is a plan view illustrating a second fan assembly shown in FIG. 2 as separated from the cooking appliance.

Referring to FIGS. 2 to 8, the blower 100 may include at least one of a first fan assembly 110 and a second fan assembly 120.

As shown in FIGS. 6 and 7, the first fan assembly 110 may include a fan housing 111, an impeller 113, and a fan motor.

The fan housing 111 may define an outer appearance of the first fan assembly 110, and may accommodate the impeller 113 therein. A suction hole 111a may be formed at a side portion of the fan housing 111. A suction hole 111a may constitute a passage necessary for the air outside the first fan assembly 110 to be suctioned into the impeller 113 in the fan housing 111.

In the present embodiment, the fan housing 111 is illustrated as being formed in a shape including a horizontally extending cylindrical shape in which both opposing sides thereof are open, and each of both opposing open sides of the fan housing 111 may be provided as the suction hole 111a.

An accommodation space for accommodating the impeller 113 therein may be formed in the fan housing 111.

The accommodation space for accommodating the impeller 113 therein may be formed inside the fan housing 111. In addition, an inner circumferential surface of the fan housing 111 defining the accommodation space may be formed as a curved surface surrounding an outer circumferential surface of the impeller 113.

A discharge hole 111b may be provided at an upper side of the fan housing 111. The discharge hole 111b constitutes a passage through which air suctioned into the accommodation space in which the impeller 113 is accommodated is discharged to the outside of the blower 100.

The discharge hole 111b may be formed to extend through the fan housing 111 in the vertical direction. Accordingly, the air suctioned into the fan housing 111 in a lateral direction through the suction hole 111a may be discharged to a position on top of the fan housing 111 through the discharge hole 111b.

The impeller 113 is constructed to be rotated about an axis extending in the lateral direction. A space into which air suctioned through a side portion of the impeller 113 is introduced is formed inside the impeller 113.

The impeller 113 may be connected to a rotation shaft of the fan motor. The rotation shaft of the fan motor rotates about an axis extending in a lateral direction, and the impeller 113 connected to the rotation shaft of the fan motor may rotate about an axis extending in a lateral direction together with the rotation shaft of the fan motor.

The first fan assembly 110 may be provided in a form in which the pair of impellers 113 are respectively disposed on both opposing sides in the lateral direction of the fan motor and the pair of fan housings 111 are respectively disposed on both opposing sides in the lateral direction of the fan motor. Hereinafter, an assembly of the impeller 113 and the fan housing 111 will be referred to as a “fan module.” In this regard, the first fan assembly 110 may be provided in a form in which a pair of fan modules are connected to both opposing sides in the lateral direction of the fan motor.

In the first fan assembly 110, the fan motor may rotate the pair of impellers 113 respectively disposed on both opposing sides thereof. As described above, the first fan assembly 110 including one fan motor and the pair of fan modules may suction air through a pair of suction holes 111a respectively disposed at both opposing sides in the lateral direction of the first fan assembly 110, and discharge air through a pair of discharge holes 111b disposed in the upper side of the first fan assembly 110.

The first fan assembly 110 configured as described above may be disposed inside the main body 10 and may be disposed in at least one of the side space 10c and the rear space 10d.

In one example, the second fan assembly 120 may be constructed to have a size slightly smaller than that of the first fan assembly 110.

In an example, as illustrated in FIGS. 2 to 5 and 8, the second fan assembly 120 may include a fan housing 121, an impeller 123, and a fan motor, which are the same as or similar to those of the first fan assembly 110, and may include the fan housing 121 and the impeller 123 which are smaller in size than those provided in the first fan assembly 110. The arrangement positions of the suction hole 121a and the discharge hole 121b are the same as those of the first fan assembly 110.

Accordingly, the second fan assembly 120 of the present embodiment may be provided in a form having a slightly smaller size than that of the first fan assembly 110 and having a slightly lower suction or discharge performance than that of the first fan assembly 110. In particular, the second fan assembly 120 may be constructed to have a shorter length in a front-rear direction than that of the first fan assembly 110.

In the second fan assembly 120, the fan motor may rotate the pair of impellers 123 respectively disposed on both opposing sides thereof. As described above, the second fan assembly 120 including one fan motor and a pair of fan modules may suction air through a pair of suction holes 121a respectively disposed at both opposing sides in the lateral direction of the second fan assembly 120, and discharge air through a pair of discharge holes 121b disposed in an upper side of the second fan assembly 120.

The second fan assembly 120 configured as described above may be disposed inside the main body 10 and may be disposed in at least one of the side space 10c and the rear space 10d.

The blower 100 of the present embodiment may include both the first fan assembly 110 and the second fan assembly 120. One of the first fan assembly 110 and the second fan assembly 120 may be disposed in the rear space 10d, and the other of the first fan assembly 110 and the second fan assembly 120 may be disposed in the side space 10c.

According to the present embodiment, the first fan assembly 110 may be disposed in the rear space 10d, that is, in a space defined between the rear surface of the cavity 11 and the rear plate 15. In addition, the second fan assembly 120 may be disposed in the side space 10c, that is, in a space defined between the side surface of the cavity 11 and the side surface of the cabinet 13.

In addition, the first fan assembly 110 may be disposed at the center in the lateral direction of the rear space 10d. That is, the first fan assembly 110 may be disposed approximately in the center area of the rear space of inside the cooking appliance.

In addition, the second fan assembly 120 may be disposed at the center in the front-rear direction of the side space 10c. That is, the second fan assembly 120 may be disposed approximately in the center area of the side space inside the cooking appliance.

In another example, the second fan assembly 120 may be disposed at a position closer to the front side or the rear side in the side space 10c.

According to the present embodiment, the first exhaust hole 103 may be disposed approximately at the center in the lateral direction of the main body 10, and may be disposed at a position closer to the rear side of the cabinet 13 and may be defined in the upper surface of the cabinet 13. That is, the first exhaust hole 103 may be disposed at a position overlapping the rear space 10d in the vertical direction.

The blower 100 of the present embodiment may include a first blower and a second blower. The first blower may be disposed in rear of the cavity 11, and the second blower may be disposed on a side of the cavity 11. That is, the first blower may be disposed in the rear space 10d, and the second blower may be disposed in the side space 10c.

Hereinafter, among the first fan assembly 110 and the second fan assembly 120, one disposed in the rear space 10d will be referred to as the first blower, and those disposed in the side space 10c will be referred to as the first blower.

In the present embodiment, it is illustrated that the first blower includes the first fan assembly 110 and the second blower includes the second fan assembly 120.

In the cooking appliance of the present embodiment, both the first exhaust hole 103 and the first fan assembly 110 may be disposed in the rear space 10d, and the first exhaust hole 103 and the first fan assembly 110 may be arranged in the vertical direction and be disposed in the rear space 10d.

In one example, a rearward protruding surface 15a may be provided on the rear plate 15 of the present embodiment. The rearward protruding surface 15a may constitute a surface that protrudes rearwards beyond the remaining area of the rear plate 15 except for the rearward protruding surface 15a.

For example, the rear plate 15 may constitute a plane orthogonal to the front-rear directional axis. In addition, the rearward protruding surface 15a may constitute a plane parallel to the rear plate 15, and may be disposed at a position protruding rearwards beyond the remaining area of the rear plate 15 except for the rearward protruding surface 15a. Preferably, the rearward protruding surface 15a may be disposed at the center in the lateral direction and the vertical direction of the rear plate 15.

The first fan assembly 110 may be disposed in front of the rear plate 15 and may be disposed in an area overlapping the rearward protruding surface 15a in the front-rear direction. Accordingly, the first fan assembly 110 may be disposed at a position protruding rearwards beyond the remaining area of the rear plate 15 except for the rearward protruding surface 15a, and may be disposed at a position further protruding rearwards by a length by which the rearward protruding surface 15a protrudes rearwards.

The rearward protruding surface 15a provided as described above may contribute to securing a space required for the installation of the blower 100 in the rear space 10d.

That is, the rearward protruding surface 15a may contribute to allowing the first fan assembly 110 having a larger size and higher performance to be applied to the blower 100.

In addition, the rearward protruding surface 15a may serve as a structure used to space the wall surface on which the cooking appliance is installed from the rear surface of the cooking appliance.

As described above, the second fan assembly 120 may be disposed in the side space 10c. Specifically, the electronic/electrical component chamber 10b may be disposed in one of the pair of side spaces 10c respectively disposed on both opposing sides of the cavity 11, and the second fan assembly 120 may be disposed in the other of the pair of side spaces 10c.

In general, the lateral length of the side space 10c in which the electronic/electrical component chamber is not disposed is set to be shorter than the length in the front-rear direction of the rear space 10d. That is, the side space 10c may provide only a space narrower than the rear space 10d.

Various devices may be disposed in the rear space 10d according to the type of the cooking appliance. For example, in the cooking appliance providing a convection function, a convection module may be disposed in the rear space 10d.

On the other hand, it is very rare that the devices are disposed in the side space 10c that does not constitute the electronic/electrical component chamber 10b. Therefore, the lateral width of the side space 10c does not need to be unnecessarily increased. When the lateral length of the side space 10c unnecessarily increases, only the overall size of the cooking appliance is increased regardless of whether the performance of the cooking appliance is improved or not.

In consideration of this fact, the side space 10c is formed to provide a space narrower than the rear space 10d.

In order to reduce the cost, it is common for cooking appliances of different types having the same cooking chamber volume to employ the main body 10 of the same size. For example, a cooking appliance that provides both a high-frequency function and a convection function may be manufactured using the main body 10 of the same size as that of the main body which a cooking appliance that provides only the high-frequency function employs.

Accordingly, the main body 10 of the present embodiment may include the rear space 10d providing a space suitable for receiving therein the convection module, and the side space 10c may be formed in a form providing only a space narrower than the rear space 10d.

As described above, the second fan assembly 120 may be provided in a smaller size than the first fan assembly 110. In consideration of this, in the present embodiment, the second fan assembly 120 is disposed in the side space 10c. That is, the second fan assembly 120, which is more suitable to be disposed in a narrow space, of the first fan assembly 110 and the second fan assembly 120 is disposed in the side space 10c.

In addition, the first fan assembly 110 may be disposed in the rear space 10d that provides more sufficient space than the side space 10c does. As the blower 100 is disposed in the rear space 10d as described above, a larger-sized and higher-performance fan assembly may be applied to the blower 100.

That is, the blower 100 may be provided in a form in which the second fan assembly 120 that is more suitable to be disposed in a narrow space is disposed in the side space 10c, and the first fan assembly 110 is disposed in the rear space 10d that provides a more sufficient space than the side space 10c does.

Accordingly, the suction or discharge performance of the blower 100 to be installed in a limited space inside the main body 10 may be maximized.

The cooking appliance of the present embodiment including the first fan assembly 110 and the second fan assembly 120 disposed as described above may provide more improved cooking gas removal performance while suppressing an increase in the size of the cooking appliance using the main body 10 of a commonly used size.

In one example, the cooking appliance of the present embodiment may include flow path defining member 140 and 150. The flow path defining member 140 and 150 is constructed to induce the flow of air discharged from the blower 100.

The flow path defining member 140 and 150 may define an exhaust flow path A1 and A2 inside the cooking appliance. The exhaust flow path A1 and A2 may connect the blower 100 and the upper space 10e to each other, and may guide the flow of air into the upper space 10e from at least one of the first fan assembly 110 and the second fan assembly 120. The exhaust flow path A1 and A2 may guide the flow of air discharged from the blower 100 toward the exhaust hole 103 and 105.

In the present embodiment, an example is illustrated in which the exhaust flow path A1 and A2 includes a first exhaust flow path A1 and a second exhaust flow path A2. In an example, the first exhaust flow path A1 may be disposed in the rear space 10d, and the second exhaust flow path A2 may be disposed in the side space 10c.

An inlet of the first exhaust flow path A1 may be opened toward the first fan assembly 110, and an inlet of the second exhaust flow path A2 may be opened toward the second fan assembly 120. In addition, an outlet of each of the first exhaust flow path A1 and the second exhaust flow path A2 may be opened toward the upper space 10e.

That is, the first exhaust flow path A1 may constitute a flow path for guiding the air flow from the discharge hole 111b of the first fan assembly 110 to the upper space 10e inside the cooking appliance. In addition, the second exhaust flow path A2 may constitute a flow path for guiding the flow of air from the discharge hole 121b of the second fan assembly 120 to the upper space 10e inside the cooking appliance.

In the present embodiment, an example is illustrated in which the flow path defining member 140 and 150 includes a first flow path defining member 140 and a second flow path defining member 150. The first flow path defining member 140 may be constructed to induce flow of air discharged from the first fan assembly 110, and the second flow path defining member 150 may be constructed to induce flow of air discharged from the second fan assembly 120.

The first flow path defining member 140 may include a fastening plate 141 and a pair of vertical plates 143.

The fastening plate 141 may be installed on the first fan assembly 110. The fastening plate 141 may open the discharge hole 111b upwardly and be coupled to the upper surface of the first fan assembly 110.

The vertical plate 143 may constitute a vertical wall extending upwardly from the fastening plate 141. The pair of vertical plates 143 may be disposed to be spaced apart from each other by a predetermined spacing in the lateral direction with the fastening plate 141 interposed therebetween.

In an example, one of the pair of vertical plates 143 may be connected to an end of one side in the lateral direction of the fastening plate 141, and the other of the pair of vertical plates 143 may be connected to an end of the other side in the lateral direction of the fastening plate 141.

In the first flow path defining member 140, the fastening plate 141 may define a lower boundary surface of the first exhaust flow path A1, and the pair of vertical plates 143 may define a left boundary surface and a right boundary surface of the first exhaust flow path A1. A rear boundary surface and a front boundary surface of the first exhaust flow path A1 may be formed defined by the rear surface of the cavity 11 and the rear plate 15, respectively.

The pair of vertical plates 143 are constructed to protrude upwardly beyond the upper surface of the cavity 11. In an example, the vertical plate 143 may protrude to a vertical level such that an upper end of the vertical plate 143 contacts the upper surface of the cabinet 13.

Accordingly, the outlet of the first exhaust flow path Al may be connected only to the upper space 10e, and the flow of air discharged from the first fan assembly 110 may be guided only to the upper space 10e through the first exhaust flow path A1.

The second flow path defining member 150 may include a fastening plate 151 and a vertical plate 153.

The fastening plate 151 may be installed on the second fan assembly 120. The fastening plate 151 may open the discharge hole 121b upwardly and be coupled to the upper surface of the second fan assembly 120.

The vertical plate 153 may constitute a vertical wall extending upwardly from the fastening plate 151. In an example, unlike the first flow path defining member 140, the second flow path defining member 150 may include only one vertical plate 153. For example, the vertical plate 153 may be connected to a rear end of the fastening plate 151.

In the second flow path defining member 150, the fastening plate 151 may define a lower boundary surface of the second exhaust flow path A2, and the vertical plate 153 may define a rear boundary surface of the second exhaust flow path A2. The left and right boundary surfaces of the second exhaust flow path A2 may be defined by the side surface of the cavity 11 and the side surface of the cabinet 13, respectively.

The vertical plate 153 is constructed to protrude upwardly beyond the upper surface of the cavity 11. In an example, the vertical plate 153 may protrude to a vertical level such that ab upper end of the vertical plate 153 contacts the upper surface of the cabinet 13.

Accordingly, an outlet of the second exhaust flow path A2 may be connected only to the upper space 10e, and the flow of air discharged from the second fan assembly 120 may be guided only to the upper space 10e through the second exhaust flow path A2.

In addition, the cooking appliance of the present embodiment may further include a first connection plate 160. The first connection plate 160 is constructed to block the gap between the first flow path defining member 140 and the second flow path defining member 150.

In an example, the first connection plate 160 is constructed to connect between the vertical plate 143 of the first flow path defining member 140 and the vertical plate 153 of the second flow path defining member 150. The first connection plate 160 may block the gap between the first flow path defining member 140 and the second flow path defining member 150, thereby preventing the air in the upper space 10e from flowing backward to the rear space 10d and the first fan assembly 110 through a gap defined between the first flow path defining member 140 and the second flow path defining member 150.

In addition, the cooking appliance of the present embodiment may further include a partitioning member 170. The partitioning member 170 may constitute a blocking wall that blocks the electronic/electrical component chamber 10b and the upper space 10e from each other, and blocks the electronic/electrical component chamber 10b and the first fan assembly 110 from each other.

The partitioning member 170 may prevent the air in the upper space 10e from flowing back to the electronic/electrical component chamber 10b, and may prevent the air in the upper space 10e from flowing back to the first fan assembly 110 through the electronic/electrical component chamber 10b.

In addition, the cooking appliance of the present embodiment may further include a second connection plate 165. The second connection plate 165 is constructed to block the gap between the first flow path defining member 140 and the partitioning member 170.

In an example, the second connection plate 165 is constructed to connect the vertical plate 143 of the first flow path defining member 140 and the partitioning member 170 to each other. The second connection plate 165 may block the gap between the first flow path defining member 140 and the partitioning member 170 from each other, thereby preventing the air in the upper space 10e from flowing backward toward the rear space 10d and the first fan assembly 110 through a gap between the first flow path defining member 140 and the partitioning member 170.

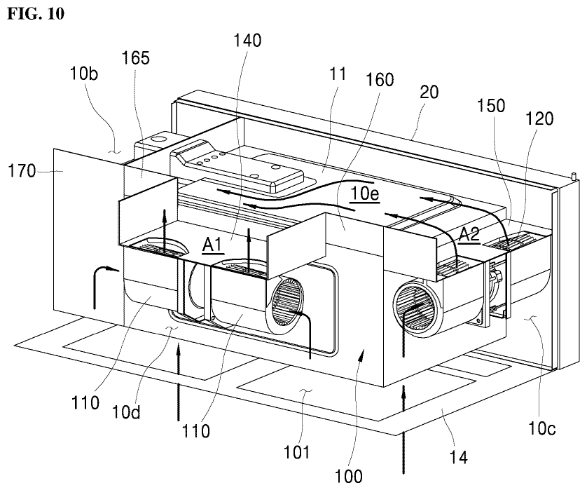

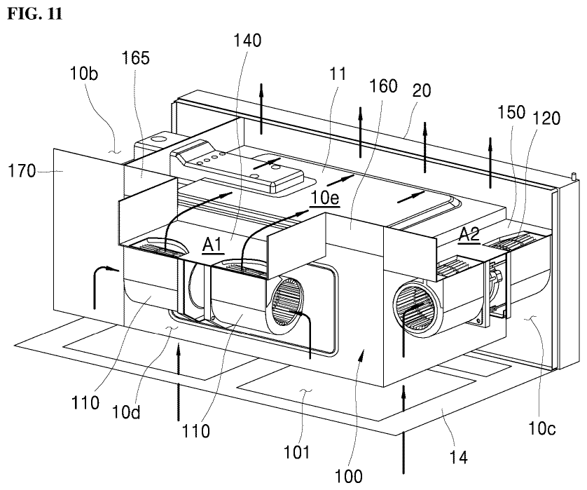

FIGS. 9 and 10 are diagram showing a state in which cooking gas is discharged to an outdoor space in a cooking appliance according to an embodiment of the present disclosure, and FIG. 11 is a diagram showing a state in which cooking gas is discharged to an indoor space in a cooking appliance according to an embodiment of the present disclosure.

Hereinafter, an operation and an effect of the cooking appliance will be described with reference to FIGS. 8 to 11.

Referring to FIGS. 8 and 9, the intake hole 101 may be provided in a lower end of the cooking appliance, and the first exhaust hole 103 and the second exhaust hole 105 may be provided in an upper end of the cooking appliance. The first exhaust hole 103 may be disposed to be closer to the rear side of the cooking appliance, and the second exhaust hole 105 may be disposed to be closer to the front side of the cooking appliance.

The blower 100 may include the first fan assembly 110, and the first fan assembly 110 may be disposed in the rear space 10d. The first fan assembly 110 may be disposed in the center in the lateral direction of the rear space 10d. Preferably, the first fan assembly 110 may be disposed at a position overlapping the first exhaust hole 103 in the vertical direction.

In addition, the blower 100 may further include the second fan assembly 120. The second fan assembly 120 may be disposed in the side space 10c.

When the operation of the first fan assembly 110 starts, suctioning airflow for suctioning air outside the cooking appliance into the cooking appliance may be generated. The suctioning airflow generated as described above acts on the external air to be suctioned through the intake hole 101 disposed at the lower end of the cooking appliance. The external air around the intake hole 101, that is, the cooking gas may flow through the intake hole 101 and be suctioned into the main body 10 under the suctioning airflow acting in this way.

The cooking gas suctioned into the main body 10 may be introduced into the rear space 10d among the spaces inside the main body 10. The cooking gas introduced into the rear space 10d as described above may be suctioned into the first fan assembly 110 through the suction holes 111a respectively disposed at both opposing sides of the first fan assembly 110, and then discharged to a position on top of the first fan assembly 110 through the discharge holes 111b respectively disposed at the upper side of the first fan assembly 110.

That is, the cooking gas introduced into the main body 10 through the intake hole 101 may flow to the upper space 10e through the first exhaust flow path Al formed in the rear space 10d. The cooking gas having flowed to the upper space 10e may be discharged to the outside through the first exhaust hole 103.

The first exhaust hole 103 may constitute a passage connecting the upper space 10e to the outside out of the cooking appliance. The first exhaust hole 103 may be disposed above the upper space 10e, and may be disposed at a position overlapping the rear space 10d in the vertical direction.

That is, the first fan assembly 110, the rear space 10d, the first exhaust flow path A1, and the first exhaust hole 103 may be disposed so as to overlap each other in the vertical direction. Preferably, the first fan assembly 110, the rear space 10d, the first exhaust flow path A1, and the first exhaust hole 103 may be aligned with each other in a line along the vertical direction.

Accordingly, the flow of air under the operation of the first fan assembly 110 may have the same straight line direction as the alignment direction of the first fan assembly 110, the rear space 10d, and the first exhaust hole 103.

As described above, when the air flows in the straight line direction, the resistance to the air flow is lowered so that the air flow may be performed more smoothly. Accordingly, air suction and discharge performance by the first fan assembly 110 may be improved, thereby improving the cooking gas removal performance of the cooking appliance.

In addition, when the first fan assembly 110 operates, the operation of the second fan assembly 120 may also be started. When the operation of the second fan assembly 120 starts, the cooking gas around the intake hole 101 may be introduced into the side space 10c. The cooking gas introduced into the side space 10c as described above may be suctioned into the inside of the second fan assembly 120 and then discharged upwardly of the second fan assembly 120.

That is, the cooking gas introduced into the main body 10 by the second fan assembly 120 may flow to the upper space 10e through the second exhaust flow path A2 formed in the side space 10c. The cooking gas flowing to the upper space 10e together with the cooking gas having flowed to the upper space 10e by the first fan assembly 110 may be discharged to the outside through the first exhaust hole 103.

According to the present embodiment, the fan assembly is disposed in both the side space 10c and the rear space 10d such that the suction or discharge performance of the blower 100 may be very effectively improved, compared to the case where the fan assembly is disposed only in the side space 10c or the rear space 10d

In one example, the cooking appliance of the present embodiment, as shown in FIG. 11, may discharge the cooking gas suctioned into the cooking appliance into the indoor space as necessary.

According to the present embodiment, a passage for discharging the cooking gas suctioned into the cooking appliance into the indoor space may be composed of the second exhaust hole 105. That is, the cooking gas introduced into the side space 10c or the rear space 10d through the intake hole 101 may flow through the upper space 10e and then be discharged to the indoor space through the second exhaust hole 105.

The cooking gas having flowed from the side space 10c or the rear space 10d to the upper space 10e may flow through a filter and be discharged into the indoor space through the second exhaust hole 105 in the state as filtered by the filter.

According to the present embodiment, the first fan assembly 110 may be disposed in the rear side of the main body 10 adjacent to the rear plate 15, and the second exhaust hole 105 may be disposed in a front side of the upper surface of the main body 10 adjacent to the door 20.

That is, the second exhaust hole 105 may be disposed to communicate with the front side of the upper space 10e, and the first fan assembly 110 may be disposed in rear of the upper space 10e. The first exhaust hole 103 may be disposed to communicate with a rear side of the upper space 10e.

According to the present embodiment, a filter for filtering cooking gas may be provided in the upper space 10e. Since the first fan assembly 110 is disposed in the rear space 10d and the second fan assembly 120 is disposed in the side space 10c, a sufficient space required for installing the filter may be secured in the upper space 10e.

That is, since the blower 100 is disposed in both the side space and the rear space of the main body 10, that is, the side space 10c and the rear space 10d, a sufficient space required for installing the filter may be secured in the upper space 10e.

If the blower 100 is disposed in the upper space 10e, a significant portion of the upper space 10e is occupied with the blower 100, such that it is difficult to secure a space required for installing the filter in the upper space 10e. In addition, if the blower 100 is disposed in the upper space 10e, there may be a problem in that the vertical length of the cooking appliance is increased.

In consideration of this fact, in the cooking appliance of the present embodiment, the blower 100 is disposed in the side space 10c and the rear space 10d. Accordingly, in the cooking appliance of the present embodiment, the installation space of the filter may be effectively secured in the upper space 10e while not increasing the vertical length of the cooking appliance.

In the cooking appliance of the present embodiment as described above, the fan assembly is disposed in both the side space 10c and the rear space 10d, thereby effectively improving the cooking gas removal performance of the cooking appliance.

In addition, the cooking appliance of the present embodiment includes the blower 100 provided in a form in which the second fan assembly 120 more suitable to be disposed in a narrow space is disposed in the side space 10c, and the first fan assembly 110 having higher performance than that of the second fan assembly 120 is disposed in the rear space 10d providing a more sufficient space than the side space 10c provides, thereby suppressing an increase in the size of the cooking appliance and providing more improved cooking gas removal performance at the same time.

In addition, in the cooking appliance of the present embodiment, the flow of the air induced by the first fan assembly 110 disposed in the rear space 10d, that is, the flow of the air introduced into the main body 10 through the intake hole 101 and discharged to the outside out of the cooking appliance through the first exhaust hole 103 has the linear straight direction, thereby minimizing the flow loss inside the cooking appliance, thereby providing more improved cooking gas removal performance.

In addition, in the cooking appliance according to the present embodiment, the filter installation space can be effectively secured in the upper space 10e, thereby providing an effect of maintaining a compact size and smoothly filtering and discharging the cooking gas to the indoor space.

### Another Embodiment of Blower

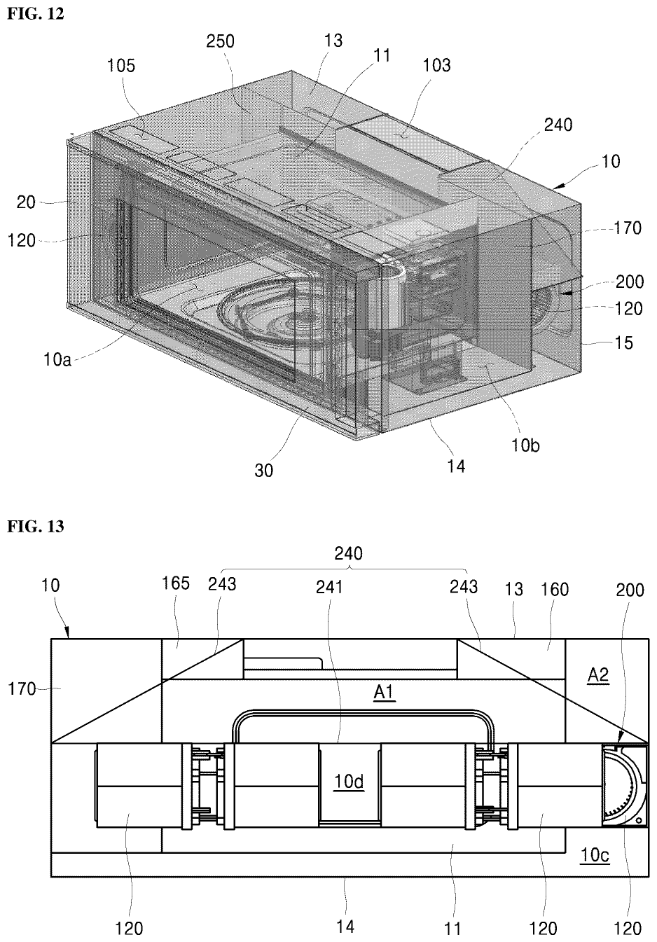

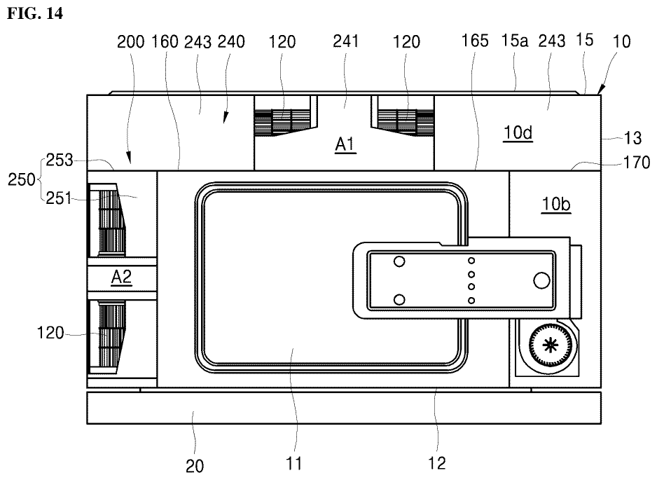

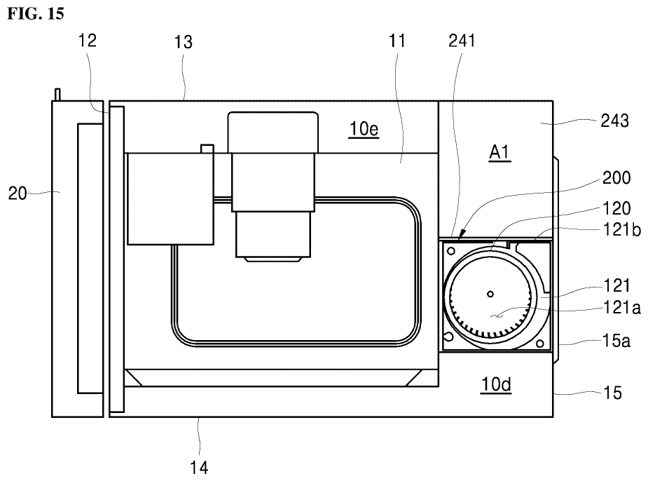

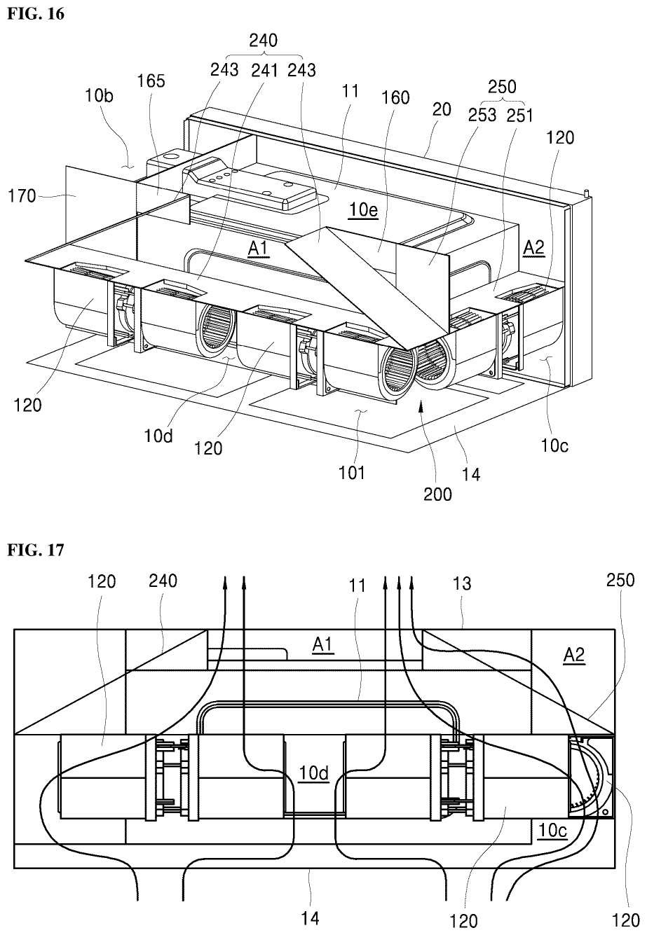

FIG. 12 is a perspective view illustrating an internal structure of a cooking appliance according to another embodiment of the present disclosure in a see-through state, FIG. 13 is a front view illustrating the internal structure of the cooking appliance illustrated in FIG. 12, and FIG. 14 is a plan view illustrating the internal structure of the cooking appliance illustrated in FIG. 12. FIG. 15 is a side view illustrating an internal structure of the cooking appliance illustrated in FIG. 12, and FIG. 16 is a rear perspective view illustrating an internal structure of the cooking appliance illustrated in FIG. 12.

Referring to FIGS. 12 to 16, a blower 200 according to another embodiment of the present disclosure may include a plurality of second fan assemblies 120.

A main difference between the blower 200 and the blower 100 (see FIG. 2) illustrated in the above-described embodiment is that the second fan assembly 120 is disposed not only in the side space 10c but also in the rear space 10d.

That is, in the present embodiment, an example is illustrated in which each of the first blower and the second blower includes the second fan assembly 120.

According to the present embodiment, the second fan assembly 120 which provides slightly lower performance than that of the first fan assembly 110, is disposed in the rear space 10d. In this regard, only one second fan assembly 120 may not be disposed in the rear space 10d, but a plurality of second fan assemblies 120 may be disposed in the rear space 10d.

That is, the plurality of second fan assemblies 120 having slightly lower performance than that of the first fan assembly 110 but smaller size than that of the first fan assembly 110 are disposed in the rear space 10d. Thus, the blower 200 according to the present embodiment may provide suction or discharge performance greater than or equal to that of the blower 100 (see FIG. 2) illustrated in the above-described embodiment.

In summary, in the present embodiment, the second fan assembly 120 having a size smaller than that of the first fan assembly 110 is disposed in the rear space 10d, and accordingly, the blower 200 may be provided so as to include a larger number of fan assemblies 120 than the number of fan assemblies included in the blower 100 illustrated in the above-described embodiment.

The blower 200 including the plurality of second fan assemblies 120 disposed in the rear space 10d may provide the suction or discharge performance higher than that of the blower 100 illustrated in the above-described embodiment. Accordingly, the cooking appliance of the present embodiment may provide more improved cooking gas removal performance.

In addition, as the second fan assembly 120 having a size smaller than that of the first fan assembly 110 is applied to the blower 200, the size of the rear space 10d to be secured for installing the blower 200 therein may be reduced. That is, as the length in the front-rear direction of the second fan assembly 120 is shortened, the length in the front-rear direction of the rear space 10d may be shortened, which may lead to a result that the length in the front-rear direction of the cooking appliance is shortened.

In other words, since the blower 200 is provided so as to include a plurality of second fan assemblies 120 having a size slightly smaller than that of the first fan assembly 110, the cooking gas removal performance of the cooking appliance may be improved and the size of the cooking appliance may be further reduced.

In addition, the cooking appliance of the present embodiment may include a flow path defining member 240 and 250. Like the flow path defining member illustrated in the above-described embodiment, the flow path defining member 240 and 250 may constitute the exhaust flow path A1 and A2 inside the cooking appliance.

In the present embodiment, an example is illustrated in which the flow path defining member 240 and 250 includes a first flow path defining member 240 and a second flow path defining member 250. The first flow path defining member 240 may be constructed to induce flow of air discharged from the first fan assembly 110, and the second flow path defining member 250 may be constructed to induce flow of air discharged from the second fan assembly 120.

The first flow path defining member 240 may include a fastening plate 241 and a pair of inclined plates 243.

The fastening plate 241 may be installed on the second fan assembly 120 disposed in the rear space 10d. The fastening plate 241 may open the discharge hole 121b upwardly and be coupled to the upper surface of the second fan assembly 120.

In an example, the fastening plate 241 may be constructed to cover all of the plurality of second fan assemblies 120 disposed in the rear space 10d while being positioned on top thereof. The fastening plate 241 may be formed to have a length corresponding to a total length in a lateral direction of the plurality of second fan assemblies 120 disposed in the rear space 10d, and may be coupled to an upper surface of each of the plurality of second fan assemblies 120 disposed in the rear space 10d.

The inclined plate 243 may constitute a vertical wall extending upwardly from the fastening plate 241. The pair of inclined plates 243 may be disposed to be spaced apart from each other by a predetermined spacing in the lateral direction with the fastening plate 241 interposed therebetween.

In an example, one of the pair of inclined plates 243 may be connected to one side end in the lateral direction of the fastening plate 241, and the other of the pair of inclined plates 243 may be connected to the other side end in the lateral direction of the fastening plate 241.

Each of the inclined plates 243 may be formed in a shape extending upwardly from the fastening plate 241. Each of the inclined plates 243 may constitute an inclined surface extending upwardly so as to be inclined toward the lateral center of the rear space 10d. The inclined plate 243 may guide the flow of air flowing through the first exhaust flow path A1 to the lateral center of the rear space 10d.

The inclined plate 243 is constructed to protrude upwardly beyond the upper surface of the cavity 11. In an example, the inclined plate 243 may protrude to a vertical level such that an upper end of the inclined plate 243 contacts the upper surface of the cabinet 13.

Accordingly, the outlet of the first exhaust flow path A1 may be connected only to the upper space 10e, and the flow of air discharged from the second fan assembly 120 may be guided only to the upper space 10e through the first exhaust flow path A1.

The second flow path defining member 250 may include a fastening plate 251 and a vertical plate 253.

The fastening plate 251 may be installed on the second fan assembly 120 disposed in the side space 10c. The fastening plate 251 may open the discharge hole 121b upwardly and be coupled to the upper surface of the second fan assembly 120.

The vertical plate 253 may constitute a vertical wall extending upwardly from the fastening plate 251. The vertical plate 253 may be disposed between the second fan assembly 120 disposed in the rear space 10d and the second fan assembly 120 disposed in the side space 10c. For example, the vertical plate 253 may be disposed between the inclined plate 243 of the first flow path defining member 240 and the second fan assembly 120 disposed in the side space 10c.

In the second flow path defining member 250, the fastening plate 251 may define a lower boundary surface of the second exhaust flow path A2, and the vertical plate 253 may define a rear boundary surface of the second exhaust flow path A2. A left boundary surface and a right boundary surface of the second exhaust flow path A2 may be defined by a side surface of the cavity 11 and a side surface of the cabinet 13, respectively.

The vertical plate 253 is constructed to protrude upwardly beyond the upper surface of the cavity 11. In an example, the vertical plate 253 may protrude to a vertical level such that an upper end of the vertical plate 253 contacts the upper surface of the cabinet 13.

Accordingly, the outlet of the second exhaust flow path A2 may be connected only to the upper space 10e, and the flow of air discharged from the second fan assembly 120 may be guided only to the upper space 10e through the second exhaust flow path A2.

In an example, the fastening plate 251 of the second flow path defining member 250 may be formed separately from the fastening plate 241 of the first flow path defining member 240. In another example, the fastening plate 251 of the second flow path defining member 250 may be integrally formed with the fastening plate 241 of the first flow path defining member 240.

In addition, the fastening plate 251 of the second flow path defining member 250 may be integrally formed with the fastening plate 241, or may be formed as a separate component therefrom.

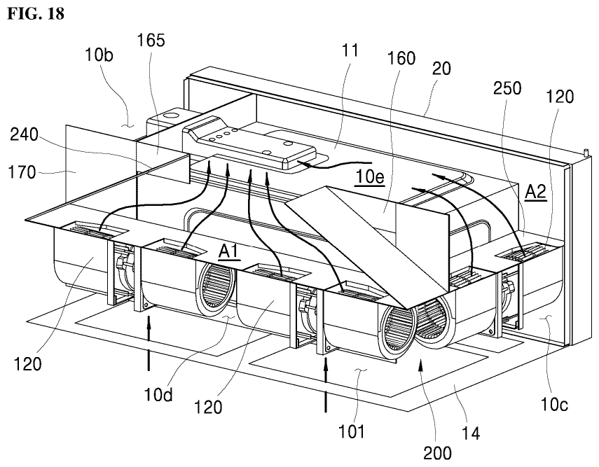

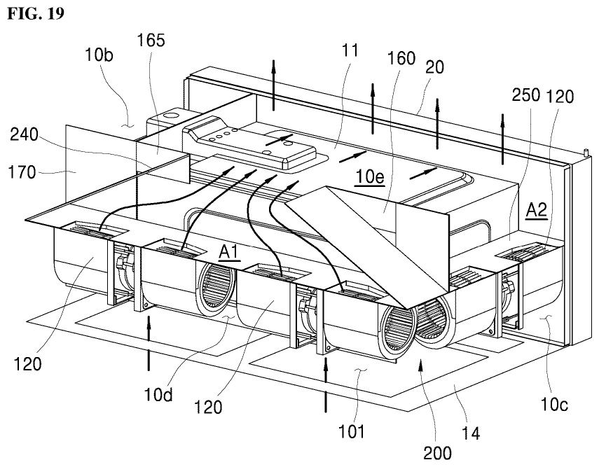

FIGS. 17 and 18 are diagrams showing a state in which cooking gas is discharged to an outdoor space in a cooking appliance according to another embodiment of the present disclosure, and FIG. 19 is a diagram showing a state in which cooking gas is discharged to an indoor space in a cooking appliance according to another embodiment of the present disclosure.

As illustrated in FIGS. 17 and 18, the cooking appliance of the present embodiment may suction the cooking gas outside the cooking appliance into the cooking appliance through the intake hole 101, and discharge the cooking gas suctioned by the blower 200 to the outside through the first exhaust hole 103. In addition, the cooking appliance may discharge the cooking gas suctioned into the cooking appliance into the indoor space through the second exhaust hole 105 as illustrated in FIG. 18.

According to the present embodiment, the plurality of second fan assemblies 120 may be laterally arranged and disposed in the rear space 10d. Each of the second fan assemblies 120 disposed as described above may be disposed adjacent to a pair of intake holes 101 arranged in the lateral direction and defined in the lower end of the main body 10, respectively.

That is, when a pair of second fan assemblies 120 are arranged in the lateral direction, the distance between the second fan assembly 120 and the intake hole 101 is also shortened, compared to when one fan assembly is disposed in the lateral center of the main body 10. Thus, the flow path connecting the second fan assembly 120 and the intake hole 101 to each other may be formed in a shape approximate to a straight line in the vertical direction.

As a result, the suction performance of the blower 200 may be improved as the distance between the second fan assembly 120 and the intake hole 101 is shortened. As the shape of the flow path is formed in a shape approximate to the straight line, the resistance to air flow may also be lowered.

That is, as the plurality of second fan assemblies 120 are laterally arranged inside the main body 10 as described above, a flow loss inside the cooking appliance is minimized, and accordingly, the cooking gas removal performance of the cooking appliance may be further improved.

In one example, referring to FIGS. 17 to 18, the second fan assembly 120 may be disposed in the rear space 10d, and may be disposed at a position lower than a position at which the first fan assembly 110 (see FIG. 3) is disposed in the above-described embodiment.

For example, compared to the case in which of the first fan assembly 110 is disposed at a vertical level equal to or higher than a vertical level of a center point in the vertical direction of the main body 10, the second fan assembly 120 of the present embodiment may be disposed at a vertical level lower than the vertical level of the center in the vertical direction of the main body 10.

According to the present embodiment, the first exhaust hole 103 may be disposed in the rear side of the upper surface of the main body 10, and may be disposed at the lateral center of the main body 10. In contrast thereto, the pair of second fan assemblies 120 are disposed at a position offset laterally from the lateral center of the main body 10.

As described above, the second fan assembly 120 is disposed at a position closer to the lateral side of the main body 10. Thus, a certain distance between the second fan assembly 120 and the first exhaust hole 103 should be secured in order that the cooking gas discharged from the second fan assembly 120 smoothly flows to the first exhaust hole 103 disposed at the lateral center of the main body 10.

The second fan assembly 120 is disposed in the rear space 10d, and thus the front-rear position of the second fan assembly 120 may be fixed. In consideration of this fact, in the present embodiment, the vertical position of the second fan assembly 120 may be changed to secure a distance between the second fan assembly 120 and the first exhaust hole 103.

That is, as the second fan assembly 120 is disposed at a vertical level as low as possible inside the main body 10, a required distance between the second fan assembly 120 and the first exhaust hole 103 may be secured.

As the second fan assembly 120 is disposed in such a manner, the air discharged from the second fan assembly 120 may smoothly flow to the first exhaust hole 103, and the distance between the second fan assembly 120 and the intake hole 101 may be shortened.

Accordingly, flow loss inside the cooking appliance may be minimized, and the cooking gas removal performance of the cooking appliance may be more effectively improved.

Although the present disclosure has been described above with reference to the embodiments illustrated in the drawings, this is merely an example, and it will be understood by those of ordinary skill in the art that various modifications and other equivalent embodiments are possible therefrom. Therefore, the true technical protection scope of the present disclosure should be determined by the following claims.

### REFERENCE NUMERALS

10: Main body
10a: Cooking chamber
10b: Electronic/electrical component chamber
10c: Side Space
10d: Reard space
10e: Upper Space
11: Cavity
12: Front Plate
13: Cabinet
14: Base Plate
15: Rear Plate
15a: Rearward protruding surface
20: Door
30: Control panel
100,200: Blower
101: Intake hole
103: First exhaust hole
105: Second exhaust hole
110: First fan assembly
111: Fan housing
111a: Suction hole
111b: Discharge hole
113: Impeller
120: Second fan assembly
121: Fan housing
121a: Suction hole
121b: Discharge hole
123: Impeller
140,240: First flow path defining member
141,241: Fastening plate
143: Vertical Plate
150,250: Second flow path defining member
151,251: Fastening plate
153,253: Vertical plate
160: First connection plate
165: Second connection plate;
170: Partitioning member
243: Inclined plate

1. A cooking appliance comprising:
a main body including a cavity having a cooking chamber defined therein; and
a blower disposed inside the main body,
wherein the main body has an intake hole disposed below the blower, and an exhaust hole disposed above the intake hole,
wherein the blower includes a first blower and a second blower configured to suction air through the intake hole and discharge the suctioned air to the exhaust hole,
wherein the first blower is disposed in rear of the cavity,
wherein the second blower is disposed on a lateral side of the cavity.

2. The cooking appliance of claim 1, wherein the main body further includes a rear plate disposed in rear of the cavity,
wherein the first blower is disposed in a rear space defined between the cavity and the rear plate.

3. The cooking appliance of claim 2, wherein a rearward protruding surface is formed on at least a portion of the rear plate,
wherein the rearward protruding surface constitutes a surface protruding rearwards beyond a remaining area of the rear plate except for the rearward protruding surface, wherein the first blower is disposed in an area overlapping the rearward protruding surface in a front-rear direction.

4. The cooking appliance of claim 1, wherein the main body further includes a cabinet having an upper surface disposed above the cavity,
wherein the exhaust hole communicates with an upper space formed between an upper surface of the cavity and an upper surface of the cabinet,
wherein the first blower and the second blower are configured to discharge the suctioned air to the upper space.

5. The cooking appliance of claim 4, wherein the exhaust hole is formed to extend through the upper surface of the cabinet.

6. The cooking appliance of claim 1, wherein the exhaust hole is disposed in an area overlapping the first blower in the vertical direction.

7. The cooking appliance of claim 1, wherein the first blower is disposed at a position overlapping the cavity in a front-rear direction.

8. The cooking appliance of claim 1, wherein the main body further includes a cabinet having a side surface disposed on the lateral side of the cavity,
wherein the second blower is disposed in a side space formed between a side surface of the cavity and a side surface of the cabinet.

9. The cooking appliance of claim 8, wherein an electronic/electrical component chamber is formed inside the main body,
wherein the side space includes a pair of side spaces respectively disposed on both opposing sides in a lateral direction of the cavity,
wherein the electronic/electrical component chamber is disposed in one of the pair of side spaces,
wherein the second blower is disposed in the other of the pair of side spaces.

10. The cooking appliance of claim 1, wherein at least one of the first blower and the second blower is disposed in an area corresponding to an area between an upper surface and a lower surface of the cavity in a vertical direction.

11. The cooking appliance of claim 1, wherein the first blower is disposed at a position closer to the intake hole than the second blower is, in the vertical direction .

12. The cooking appliance of claim 1, wherein the first blower includes at least one of a first fan assembly and a second fan assembly,
wherein the second blower includes the second fan assembly,
wherein each of the first fan assembly and the second fan assembly has:
a suction hole disposed to face in a lateral direction or a front-rear direction; and
a discharge hole disposed to face upwardly,
wherein in the first blower, the suction hole of each of the first fan assembly and the second fan assembly is disposed to face in the lateral direction,
wherein in the second blower, the suction hole of the second fan assembly is disposed to face in the front-rear direction.

13. The cooking appliance of claim 12, wherein in a direction perpendicular to both a direction in which the suction hole faces and a direction in which the discharge hole faces, a length of the second fan assembly is smaller than a length of the first fan assembly.

14. The cooking appliance of claim 12, wherein the first blower includes a plurality of second fan assemblies arranged laterally.

15. The cooking appliance of claim 12, wherein in the first blower, a vertical position of the second fan assembly is closer to the intake hole than to the exhaust hole.
